(19) United States
(12) Patent Application Publication
(10) Pub. No.: US 2026/0330978 A1
(43) Pub. Date: Oct. 22, 2026

(54) INFORMATION PROCESSING APPARATUS, INFORMATION PROCESSING METHOD, AND INFORMATION PROCESSING SYSTEM

(71) Applicant: SONY GROUP CORPORATION, TOKYO (JP)

(72) Inventors: SHOTA TAKAHASHI, TOKYO (JP); SHINSUKE TAKUMA, TOKYO (JP); ERIO AKANUMA, TOKYO (JP)

(21) Appl. No.: 19/486,512

(22) PCT Filed: May 27, 2024
(86) PCT No.: PCT/JP2024/019386

§ 371 Date: Nov. 21, 2025

(30) Foreign Application Priority Data
Jun. 13, 2023 (JP) 2023-096724

(51) Int. Cl. G08G 5/23; G08G 5/22; G08G 5/57; G08G 5/80

(52) U.S. Cl. CPC G08G 5/23; G08G 5/22; G08G 5/57; G08G 5/80

(57) ABSTRACT

The present technology relates to an information processing apparatus, an information processing method, and an information processing system that facilitate determination of validity of an execution plan for an autonomous mobile object to execute a mission.

An information processing apparatus according to the present technology includes an output control unit that controls display of execution plan information regarding an execution plan for an autonomous mobile object to execute a mission, area information regarding an execution area where the mission is to be executed, and additional information applicable to determination of validity of the execution plan. The present technology can be applied to, for example, an information processing apparatus that sets a mission to be executed by a drone.

### TECHNICAL FIELD

The present technology relates to an information processing apparatus, an information processing method, and an information processing system, and more particularly, to an information processing apparatus, an information processing method, and an information processing system that facilitate determination of validity of a movement route of an autonomous mobile object.

### BACKGROUND ART

Conventionally, a technology has been proposed in which a flight route image including a flight route depicted in a virtual space is generated, and a composite image superimposed on a captured image acquired on the basis of imaging state information is displayed on a user terminal, so that validity of a flight route of a drone can be confirmed (see, for example, Patent Document 1).

### CITATION LIST

### Patent Document

### Patent Document 1: Japanese Patent Application Laid-Open No. 2021-104802

### SUMMARY OF THE INVENTION

### Problems to be Solved by the Invention

On the other hand, in recent years, drones autonomously fly and autonomously execute a mission to image designated areas, buildings, and the like.

Accordingly, it is required to facilitate determination of validity of an execution plan for a drone to execute a mission.

The present technology has been made in view of such a situation, and facilitate determination of validity of an execution plan for an autonomous mobile object such as a drone to execute a mission.

### Solutions to Problems

An information processing apparatus according to a first aspect of the present technology includes an output control unit that controls display of execution plan information regarding an execution plan for an autonomous mobile object to execute a mission, area information regarding an execution area where the mission is to be executed, and additional information applicable to determination of validity of the execution plan.

In an information processing method according to the first aspect of the present technology, an information processing apparatus controls display of execution plan information regarding an execution plan for an autonomous mobile object to execute a mission, area information regarding an execution area where the mission is to be executed, and additional information applicable to determination of validity of the execution plan.

An information processing system according to a second aspect of the present technology includes: an execution plan creation unit that creates an execution plan for an autonomous mobile object to execute a mission on the basis of mission information regarding the mission to be executed by the autonomous mobile object and area information regarding an execution area where the mission is to be executed; an additional information generation unit that generates additional information applicable to determination of validity of the execution plan on the basis of execution plan information regarding the execution plan and the area information; and an output control unit that controls display of the execution plan information, the area information, and the additional information.

In the first aspect of the present technology, the display is controlled of the execution plan information regarding the execution plan for the autonomous mobile object to execute the mission, the area information regarding the execution area where the mission is to be executed, and the additional information applicable to the determination of the validity of the execution plan.

In the second aspect of the present technology, the execution plan for the autonomous mobile object to execute the mission is created on the basis of the mission information regarding the mission to be executed by the autonomous mobile object and the area information regarding the execution area where the mission is to be executed, the additional information applicable to the determination of the validity of the execution plan is generated on the basis of the execution plan information regarding the execution plan and the area information, and the display is controlled of the execution plan information, the area information, and the additional information.

### BRIEF DESCRIPTION OF DRAWINGS

FIG. 1 is a block diagram illustrating an embodiment of an information processing system to which the present technology is applied.

FIG. 2 is a block diagram illustrating a functional configuration example of a user terminal.

FIG. 3 is a block diagram illustrating a functional configuration example of a server.

FIG. 4 is a flowchart for explaining execution plan creation processing.

FIG. 5 is a diagram illustrating an example of a mission setting screen.

FIG. 6 is a diagram illustrating an example of the mission setting screen.

FIG. 7 is a diagram illustrating a display example of an execution plan.

FIG. 8 is a diagram illustrating a display example of the execution plan.

FIG. 9 is a diagram illustrating a display example of the execution plan.

FIG. 10 is a diagram illustrating a display example of the execution plan.

FIG. 11 is a diagram illustrating a display example of the execution plan.

FIG. 12 is a diagram illustrating a display example of the execution plan.

FIG. 13 is a diagram illustrating a display example of the execution plan.

FIG. 14 is a diagram illustrating a display example of an execution plan.

FIG. 15 is a diagram illustrating a display example of an execution plan.

FIG. 16 is a diagram illustrating a display example of the execution plan, and a flight roue during flight.

FIG. 17 is a diagram illustrating a display example of the execution plan, and a flight route after the flight.

FIG. 18 is a block diagram illustrating a configuration example of a computer.

### MODE FOR CARRYING OUT THE INVENTION

Hereinafter, modes for carrying out the present technology will be described. The description will be given in the following order.
1. Embodiment
2. Modifications
3. Others

### 1. Embodiment

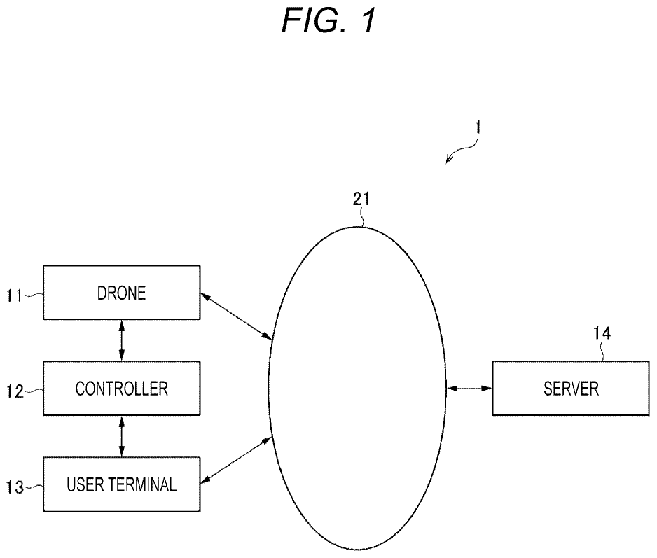

An embodiment of the present technology will be described with reference to FIG. 1 to FIG. 15.

### <Configuration Example of Information Processing System 1>

First, a configuration example of an information processing system 1 to which the present technology is applied will be described with reference to FIG. 1. The information processing system 1 is, for example, a system that creates an execution plan for a drone 11 to execute a given mission (command) and controls flight operation of the drone 11 according to the execution plan.

Here, content of the mission is not particularly limited as long as it is autonomously executable by the drone 11. For example, the drone 11 is given a mission of imaging a designated area or object (for example, a building, a structure, or the like) for inspection, surveying, or the like. Specifically, for example, the drone 11 is given a mission of comprehensively imaging the inside of a designated area (hereinafter, referred to as an imaging target area). For example, the drone 11 is given a mission of comprehensively imaging a surface of a designated object (hereinafter, referred to as an imaging target object). For example, the drone 11 is given a mission or the like of moving to each of imaging points according to a list of designated imaging points (hereinafter, referred to as an imaging point list) and performing imaging.

Hereinafter, the imaging target area and the imaging target object are collectively referred to as an imaging target. Note that, in the case of a mission of performing imaging according to an imaging point list, imaging points are designated, whereby an imaging target area or an imaging target object imaged from each imaging point is indirectly designated as an imaging target.

The information processing system 1 includes the drone 11, a controller 12, a user terminal 13, and a server 14.

The drone 11, the user terminal 13, and the server 14 are interconnected via a network 21 and can communicate with each other. The network 21 includes various networks such as the Internet and a mobile phone network, a base station, an access point, and the like.

The drone 11 can directly perform wireless communication with the controller 12 by a predetermined communication method. As a communication method between the drone 11 and the controller 12, for example, a 2.4 GHz band spread spectrum method or the like is used.

The drone 11 can be connected to the network 21 by, for example, wireless communication such as Wi-Fi or mobile communication such as 4G or 5G. Thus, the drone 11 can communicate with the user terminal 13, the server 14, and the like via the network 21.

The drone 11 includes an imaging device such as a camera, and can image surroundings of the drone 11.

The drone 11 can fly by remote operation by the controller 12 or the user terminal 13. Furthermore, the drone 11 can fly autonomously without remote operation by the controller 12 and the user terminal 13. For example, the drone 11 can execute a given mission while flying autonomously in accordance with execution plan information given from the controller 12, the user terminal 13, or the server 14.

The controller 12 includes, for example, a proportional system. As described above, the controller 12 can directly perform wireless communication with the drone 11, and is used for remote operation of the drone 11.

The controller 12 can directly perform wireless communication or wired communication with the user terminal 13 by a predetermined communication method. As a communication method between the controller 12 and the user terminal 13, a method is used, for example, a short-range wireless communication method such as Bluetooth (registered trademark) or a wired communication method using a universal serial bus (USB) cable or the like.

The user terminal 13 includes, for example, an information processing terminal such as a smartphone, a tablet terminal, or a personal computer (PC). The user terminal 13 can be connected to the network 21 by wireless communication such as Wi-Fi or mobile communication such as 4G or 5G. Thus, the user terminal 13 can communicate with the drone 11, the server 14, and the like via the network 21.

By executing a predetermined application, the user terminal 13 can execute creation of an execution plan for the drone 11 to execute a mission given by a user, remote operation of the drone 11, and the like.

The server 14 can communicate with the drone 11 and the user terminal 13 via the network 21. The server 14 provides, for example, information necessary for the user terminal 13 to create the execution plan.

Note that, although not illustrated, a plurality of sets of the drone 11, the controller 12, and the user terminal 13 is provided in the information processing system 1. Furthermore, the numbers of the drones 11, the controllers 12, and the user terminals 13 of each set can be arbitrarily set. For example, a plurality of the controllers 12 or a plurality of the user terminals 13 may be provided for one drone 11. For example, a plurality of the drones 11 may be provided for one controller 12, or a plurality of the drones 11 may be provided for one user terminal 13. For example, one of the controller 12 or the user terminal 13 may be omitted.

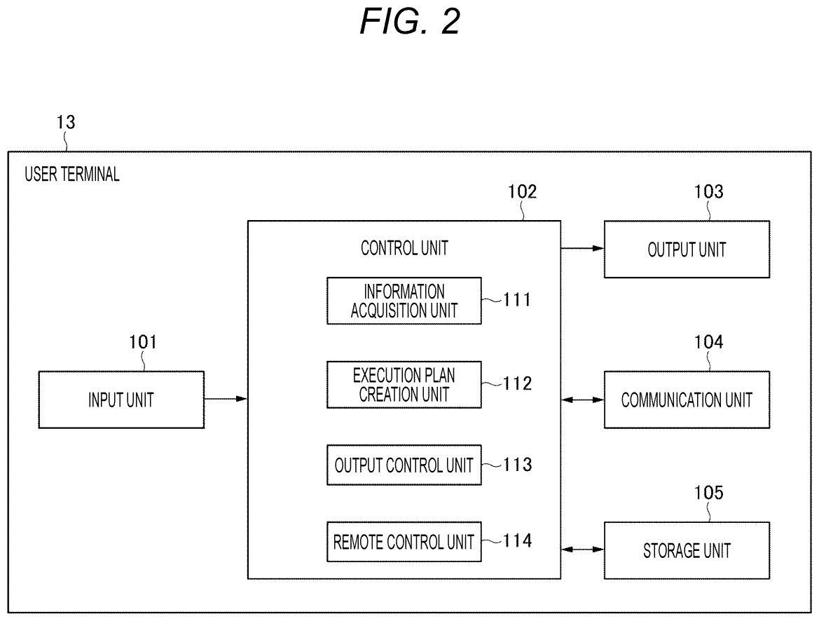

FIG. 2 illustrates a functional configuration example of the user terminal 13.

The user terminal 13 includes an input unit 101, a control unit 102, an output unit 103, a communication unit 104, and a storage unit 105.

The input unit 101 includes various input devices and operation devices, and is used for receiving various types of information as inputs and operating the user terminal 13. The input unit 101 supplies input information input by use of an input device or an operation device to the control unit 102.

The control unit 102 includes a processor such as a CPU, a memory, and the like. The control unit 102 executes a predetermined program to control each unit of the user terminal 13 and execute various types of processing. The control unit 102 includes an information acquisition unit 111, an execution plan creation unit 112, an output control unit 113, and a remote control unit 114.

The information acquisition unit 111 acquires various types of information from the outside via the communication unit 104. For example, the information acquisition unit 111 receives area information and additional information from the server 14 via the network 21 and the communication unit 104.

The area information includes information regarding an area (hereinafter, referred to as an execution area) where the drone 11 executes a mission.

For example, in the case of a mission of imaging an imaging target (an imaging target area or an imaging target object), an area including the imaging target is an execution area. For example, in the case of a mission of performing imaging according to an imaging point list, an area including each imaging point and an imaging target to be imaged from each imaging point is an execution area.

The additional information includes information applicable to determination of validity of the execution plan created by the execution plan creation unit 112 by the user. In other words, the additional information includes auxiliary information for assisting the determination of the validity of the execution plan by the user.

The execution plan creation unit 112 creates an execution plan for the drone 11 to execute a mission on the basis of mission information regarding the mission given by the user via the input unit 101, the area information, and device information as necessary.

The device information includes information regarding, for example, an imaging device such as a camera included in the drone 11, and the drone 11 itself.

The execution plan creation unit 112 transmits the execution plan information regarding the execution plan and the device information to the server 14 via the communication unit 104 and the network 21. The execution plan creation unit 112 transmits the execution plan information to the controller 12 via the communication unit 104, and transmits the execution plan information to the drone 11 via the communication unit 104 and the network 21.

The output control unit 113 controls output of various types of information (for example, visual information, auditory information, and tactile information) from the output unit 103.

The remote control unit 114 executes remote control of the flight operation of the drone 11. For example, the remote control unit 114 generates an operation command or a control parameter for remotely controlling the drone 11, and transmits the operation command or the control parameter to the drone 11 via the communication unit 104 and the network 21.

The output unit 103 includes various output devices that output visual information, auditory information, or tactile information. For example, the output unit 103 includes a display device, an audio output device, a haptics device, and the like. The output unit 103 outputs various types of information under the control of the output control unit 113.

The communication unit 104 includes various communication devices and performs wireless communication with other apparatuses by a predetermined communication method. For example, the communication unit 104 communicates with the drone 11, the server 14, and the like via the network 21. For example, the communication unit 104 performs direct wireless communication or wired communication with the controller 12.

The storage unit 105 includes, for example, a nonvolatile memory, and stores various types of information necessary for processing by the user terminal 13. For example, the storage unit 105 stores the device information regarding the imaging device included in the drone 11 and the drone 11 itself.

### <Configuration Example of Server 14>

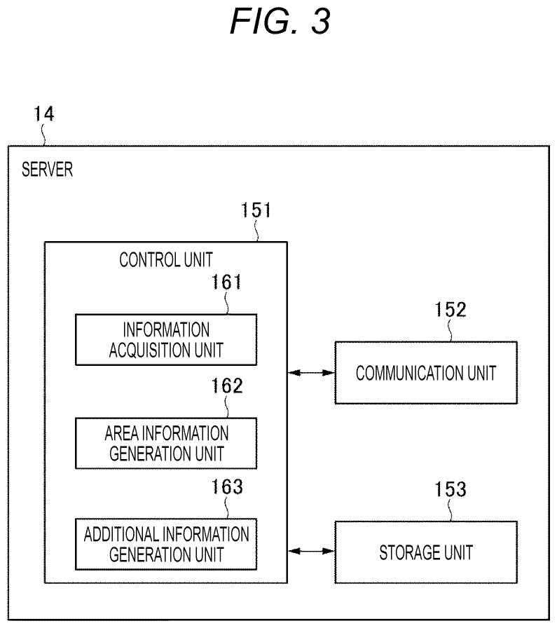

FIG. 3 illustrates a functional configuration example of the server 14.

The server 14 includes a control unit 151, a communication unit 152, and a storage unit 153.

The control unit 151 includes a processor such as a CPU, a memory, and the like. The control unit 151 controls each unit of the server 14 and executes various types of processing by executing a predetermined program. The control unit 151 includes an information acquisition unit 161, an area information generation unit 162, and an additional information generation unit 163.

The information acquisition unit 161 acquires various types of information from the outside via the communication unit 152. For example, the information acquisition unit 161 receives the execution plan information and the device information from the user terminal 13 via the network 21 and the communication unit 152.

The area information generation unit 162 generates area information regarding an execution area where the drone 11 executes a mission on the basis of at least one of map information, an image, a two-dimensional model, or a three-dimensional model of each of places stored in the storage unit 153. The area information generation unit 162 transmits the area information to the user terminal 13 via the communication unit 152 and the network 21.

The additional information generation unit 163 generates additional information including information applicable to determination of validity of the execution plan on the basis of the execution plan information, the device information, and the area information. The additional information generation unit 163 transmits the additional information to user terminal 13 via the communication unit 152 and the network 21.

The communication unit 152 includes various communication devices and performs communication with other apparatuses by a predetermined communication method. For example, the communication unit 152 communicates with the drone 11, the user terminal 13, and the like via the network 21.

The storage unit 153 includes, for example, a nonvolatile memory, and stores various types of information necessary for processing by the server 14. For example, the storage unit 153 stores at least one of the map information, the image, the two-dimensional model, and the three-dimensional model of each place. The map information includes, for example, a two-dimensional or three-dimensional map of each place. The three-dimensional model is a model indicating a three-dimensional shape of a structure, a terrain, or the like. The two-dimensional model is, for example, a model indicating a two-dimensional shape of a structure, terrain, or the like near the execution area.

### <Execution Plan Creation Processing>

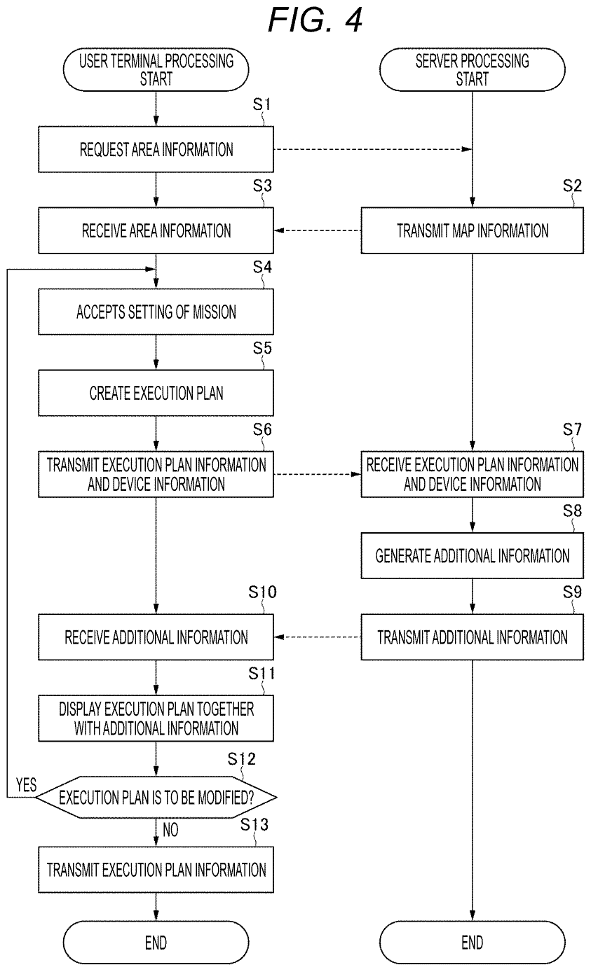

Next, execution plan creation processing executed by the information processing system 1 will be described with reference to a flowchart of FIG. 4.

This processing is executed, for example, between the user terminal 13 and the server 14.

In step S1, the user terminal 13 requests area information.

For example, the user inputs information regarding an execution area where the drone 11 executes a mission via the input unit 101. The input unit 101 supplies, to the control unit 102, input information including the information input.

The information acquisition unit 111 generates area information request information for requesting the area information regarding the execution area. The information acquisition unit 111 transmits the area information request information to the server 14 via the communication unit 104 and the network 21.

In response to this, in step S2, the server 14 transmits the area information.

Specifically, the information acquisition unit 161 of the server 14 receives the area information request information from the user terminal 13 via the network 21 and the communication unit 152.

The area information generation unit 162 generates the area information regarding the execution area on the basis of the area information request information and at least one of the map information, the image, the two-dimensional model, or the three-dimensional model of each place stored in the storage unit 153.

The area information includes information necessary for the user to set the mission and confirm an execution plan for executing the mission. For example, the area information includes at least one of map information, an image, a three-dimensional model, or a two-dimensional model near the execution area.

The area information generation unit 162 transmits the area information to the user terminal 13 via the communication unit 152 and the network 21.

In response to this, in step S3, the information acquisition unit 111 of the user terminal 13 receives the area information from the server 14 via the network 21 and the communication unit 104.

Note that, although not described in the flowchart, the processing of step S1 to step S3 is appropriately executed, for example, every time new area information is required in the user terminal 13.

In step S4, the user terminal 13 accepts setting of the mission.

For example, in order to perform inspection, surveying, or the like of a desired area or object, the drone 11 is given a mission of imaging the area (imaging target area) or the vicinity of the object (imaging target object), or a mission of performing imaging according to an imaging point list for imaging the imaging target area or the imaging target object.

For example, the output unit 103 displays a setting screen (hereinafter, referred to as a mission setting screen) for setting a mission executed by the drone 11 under the control of the output control unit 113.

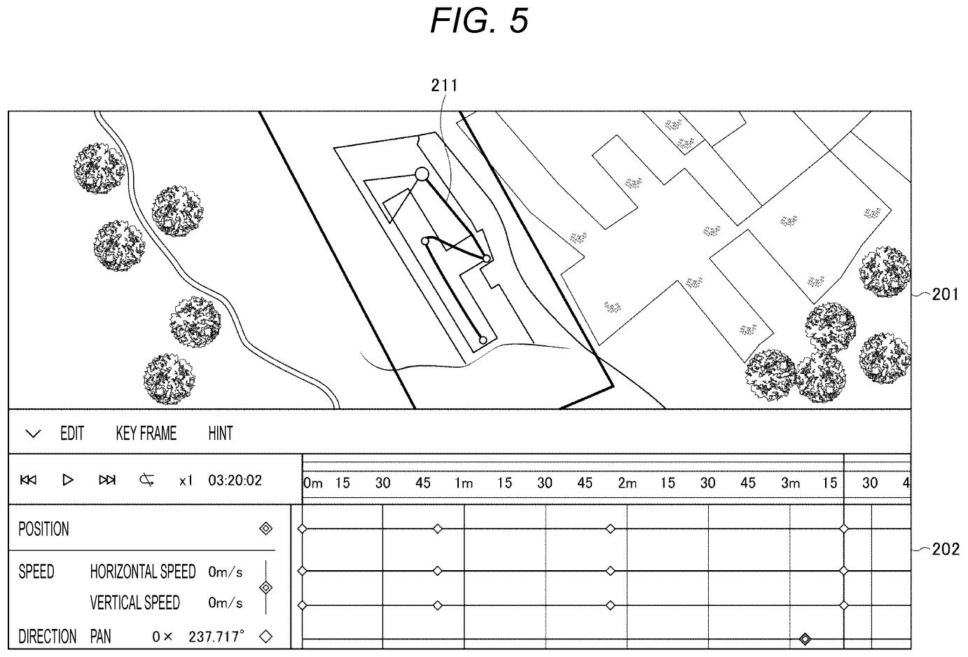

FIG. 5 illustrates an example of the mission setting screen.

The mission setting screen is divided into an area information display section 201 and an operation section 202.

The area information display section 201 displays area information near the execution area, for example, the map information, image, three-dimensional model, or two-dimensional model near the execution area.

Various operation parts for performing mission setting operation and the like are displayed on the operation section 202.

For example, the user can set time-series movement of the drone 11 on the mission setting screen.

Specifically, for example, the user can set a time-series position (for example, latitude, longitude, and altitude), a speed (for example, horizontal speed and vertical speed), and the like of the drone 11.

For example, the user can set a time-series imaging condition of an imaging device such as a camera included in the drone 11 (hereinafter, simply referred to as an imaging device of the drone 11) on the mission setting screen. Specifically, for example, the user can set an imaging target area, an imaging target object, an imaging point where the imaging device of the drone 11 performs imaging, and an imaging direction, a focus position, exposure, and the like of the imaging device of the drone 11.

Note that, hereinafter, a fact that the imaging device of the drone 11 performs imaging or the like is simply referred to as a fact that the drone 11 performs imaging or the like.

In step S5, the execution plan creation unit 112 of the user terminal 13 creates an execution plan on the basis of the mission information regarding the mission set by the user, the area information, and the device information as necessary. For example, the execution plan includes a start time, an end time, a flight route (movement route), a flight speed, an imaging condition, and the like.

Note that the user does not necessarily have to set all the items at the time of setting the mission. The item not set by the user is automatically set, for example, when the execution plan creation unit 112 creates the execution plan.

For example, the flight route may be set by the user, or may be automatically set by the execution plan creation unit 112 on the basis of the mission set by the user.

For example, the mission setting screen of FIG. 5 illustrates an example in which a flight route 211 is set by the user.

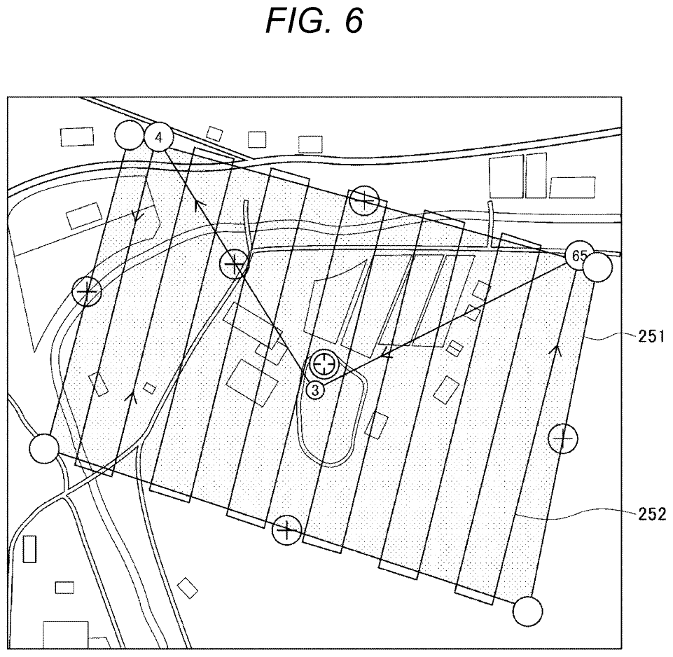

For example, FIG. 6 illustrates an example in which, when an imaging target area 251 is set by the user, the flight route 211 is automatically set by the execution plan creation unit 112 so that the imaging target area 251 can be fully imaged.

Note that circled numbers in FIG. 6 indicate the order of a flight route 252, and a part thereof is not illustrated. A circled + is used to add a vertex to the imaging target area 251. When a circular mark at the center of the imaging target area 251 is dragged and dropped, the entire imaging target area 251 moves.

Note that, hereinafter, the flight route planned in the execution plan is referred to as a planned route.

In step S6, the execution plan creation unit 112 of the user terminal 13 transmits the execution plan information and the device information via the communication unit 104 and the network 21.

The execution plan information includes information regarding the execution plan created in step S5.

The device information includes, for example, information regarding an imaging device such as a camera included in the drone 11 and the drone 11 itself. The information regarding the imaging device includes, for example, information regarding a model name, equipment, function, performance, and the like of the imaging device. The information regarding the drone 11 itself includes, for example, information regarding a model name, equipment, function, performance, and the like of the drone 11.

In response to this, in step S7, the information acquisition unit 161 of the server 14 receives the execution plan information and the device information via the network 21 and the communication unit 152.

In step S8, the additional information generation unit 163 of the server 14 generates additional information. Specifically, the additional information generation unit 163 generates additional information applicable to determination of validity of the execution plan on the basis of the area information, the execution plan information, and the device information.

For example, the additional information generation unit 163 calculates a distance between the planned route of the drone 11 and an object around the planned route on the basis of the area information and the execution plan information (particularly, the planned route).

On the basis of a distance between the planned route and a surrounding object, the additional information generation unit 163 sets, in the planned route, a section (hereinafter, referred to as a caution-needed section) in which there is a risk that the drone 11 collides with or comes into contact with the object around the planned route and caution is needed. For example, the additional information generation unit 163 sets, in the planned route, a section whose distance to a surrounding object is less than a threshold (hereinafter, referred to as an approach determination threshold) as the caution-needed section.

Note that the approach determination threshold may be changed on the basis of at least one of operation information such as speed and acceleration of the drone 11, environmental information around the planned route (drone 11), and information regarding the imaging device of the drone 11.

For example, the additional information generation unit 163 increases the approach determination threshold as the speed of the drone 11 increases, and decreases the approach determination threshold as the speed of the drone 11 decreases. For example, in a section in which the drone 11 flies at a speed of 10 m/s, the approach determination threshold is set to 10 m, and in a section in which the drone 11 flies at a speed of 1 m/s, the approach determination threshold is set to 1 m. As a result, for example, in the section in which the drone 11 flies at the speed of 10 m/s, a section having a distance less than or equal to 10 m from a surrounding object is set as the caution-needed section. On the other hand, in the section in which the drone 11 flies at the speed of 1 m/s, a section having a distance less than or equal to 1 m from a surrounding object is set as the caution-needed section.

For example, the additional information generation unit 163 changes the approach determination threshold on the basis of predicted values and the like of the sunlight amount, the weather, and the wind speed around the drone 11. For example, in a case where the drone 11 flies in the daytime, the approach determination threshold may be set to 10 m, and in a case where it flies at night, the approach determination threshold may be set to 5 m.

For example, the additional information generation unit 163 changes the approach determination threshold on the basis of a focal length of the imaging device of the drone 11. For example, in a case where the focal length is 50 mm, it is difficult to see the surroundings if the imaging device is too close to the imaging target, and thus the approach determination threshold is set to 5 m. On the other hand, in a case where the focal length is 24 mm, it is possible to perform imaging at a position closer to the imaging target than in a case where the focal length is 50 mm, and thus the approach determination threshold is set to 2 m.

For example, the additional information generation unit 163 calculates an imaging state at each imaging point of the drone 11 on the basis of the area information, the execution plan information, and the device information. For example, the additional information generation unit 163 calculates an imaging range by the imaging device of the drone 11 at each imaging point, an imaging direction for the imaging target, a focus state with respect to the imaging target, resolution of the imaging target, and the like.

The additional information generation unit 163 generates additional information including information regarding a distance between the planned route and a surrounding object, information regarding the caution-needed section, and information regarding the imaging state of the drone 11 (hereinafter, referred to as imaging state information) at each imaging point.

In step S9, the additional information generation unit 163 of the server 14 transmits the additional information to the user terminal 13 via the communication unit 152 and the network 21.

In response to this, in step S10, the control unit 102 of the user terminal 13 receives the additional information from the server 14 via the network 21 and the communication unit 104.

In step S11, the output unit 103 of the user terminal 13 displays the execution plan together with the additional information under the control of the output control unit 113.

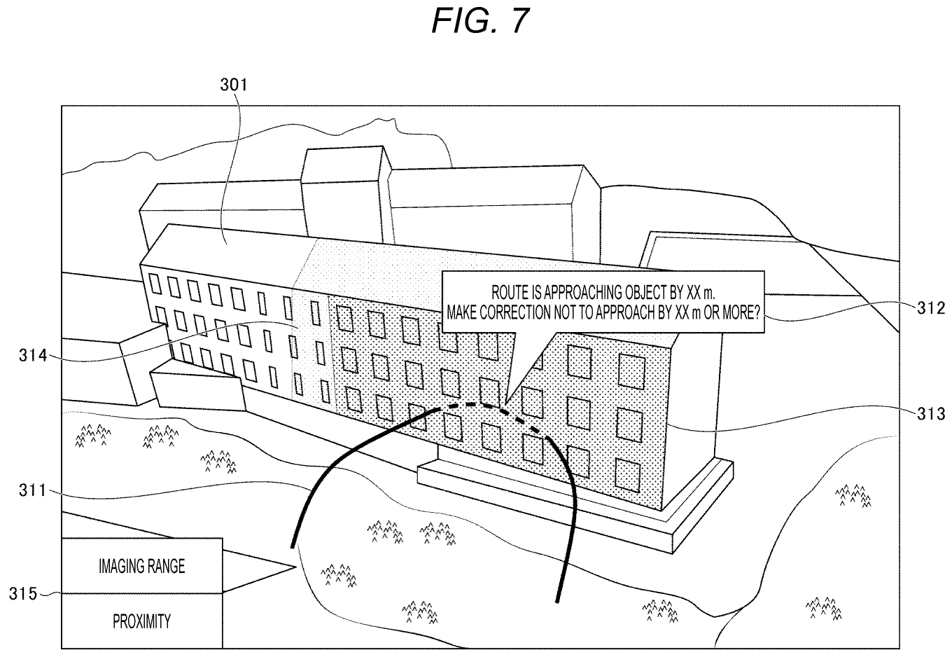

Here, display examples of execution plans will be described with reference to FIG. 7 to FIG. 14.

FIG. 7 to FIG. 13 illustrate display examples of an execution plan in a case where a mission is given of imaging a building 301.

In the example of FIG. 7, a three-dimensional model near the building 301 is displayed as area information, and a planned route 311 is superimposed on the area information. Furthermore, a message 312, an imaging range 313, an imaging range 314, and a menu 315 are superimposed on the area information as additional information.

The planned route 311 indicates, by a line, a route on which the drone 11 is scheduled to fly in the execution plan. In the planned route 311, the caution-needed section has a display mode different from other sections. In this example, in the planned route 311, a section in which a distance to the building 301 is less than the approach determination threshold is displayed as the caution-needed section by a dotted line. In this way, the caution-needed section, which is one of the additional information, is displayed by a change in the display mode of the planned route 311.

Note that the display modes of the caution-needed section and sections other than the caution-needed section are not particularly limited as long as they can be distinguished from each other. For example, the caution-needed section and the sections other than the caution-needed section are distinguished from each other by color, line type, and the like.

The message 312 performs notification of a message for the caution-needed section of the planned route 311. Specifically, it is indicated that the planned route 311 of the drone 11 is approaching the object (building 301) within a predetermined distance range. Furthermore, a message is indicated for confirming whether or not to correct the planned route 311 so that the drone 11 does not approach the object (building 301) by a predetermined distance or more.

As a result, the user can recognize in advance a risk that the drone 11 collides with or comes into contact with a surrounding object.

The imaging range 313 and the imaging range 314 indicate ranges scheduled to be imaged by the drone 11 in the execution plan. The imaging range 313 and the imaging range 314 are displayed in different display modes on the basis of the imaging states by the drone 11, for example, focus states. The imaging range 313 indicates a range estimated to be in focus among the ranges scheduled to be imaged by the drone 11. The imaging range 314 indicates a range estimated to be out of focus among the ranges scheduled to be imaged by the drone 11.

Note that the display modes of the imaging range 313 and the imaging range 314 are not particularly limited as long as they can be distinguished from each other. For example, the imaging range 313 and the imaging range 314 are distinguished from each other by color, pattern, and the like.

As a result, the user can recognize in advance whether or not the imaging target can be imaged as intended. Specifically, for example, the user can recognize in advance an imaging range of the imaging target and a range in which the imaging target can be finely imaged and a range in which the imaging target cannot be finely imaged.

Note that, for example, the display mode of the imaging range may be changed on the basis of the imaging direction for the imaging target. For example, the imaging range 313 may indicate a range within a range of 90 degrees ±α with respect to the optical axis of the imaging device (camera) of the drone 11, and the imaging range 314 may indicate a range outside the range of 90 degrees ±α with respect to the optical axis of the camera of the drone 11.

As a result, the user can recognize in advance the imaging range of the imaging target and whether or not the imaging target can be imaged from a facing position.

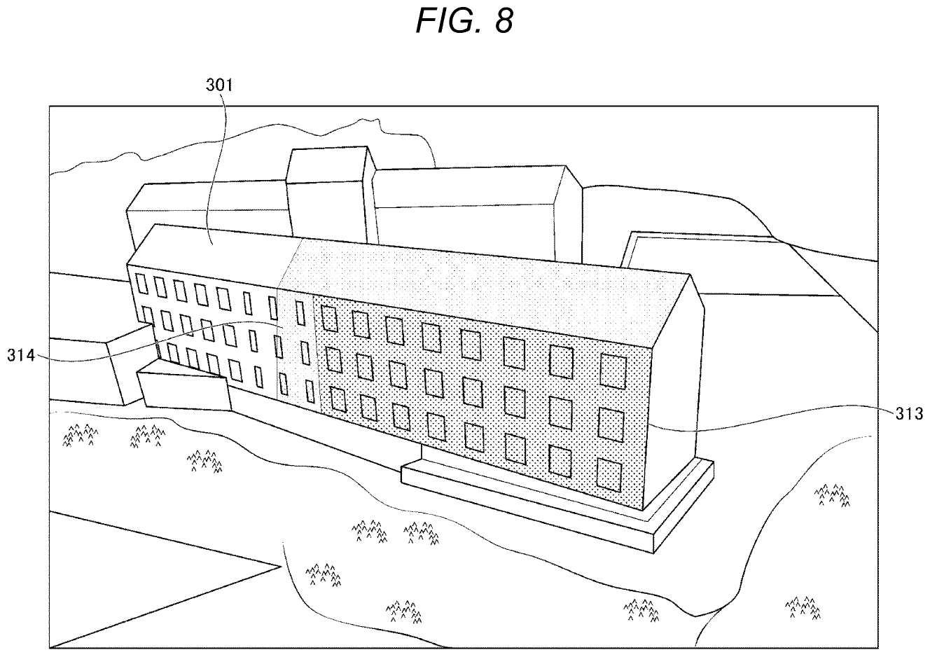

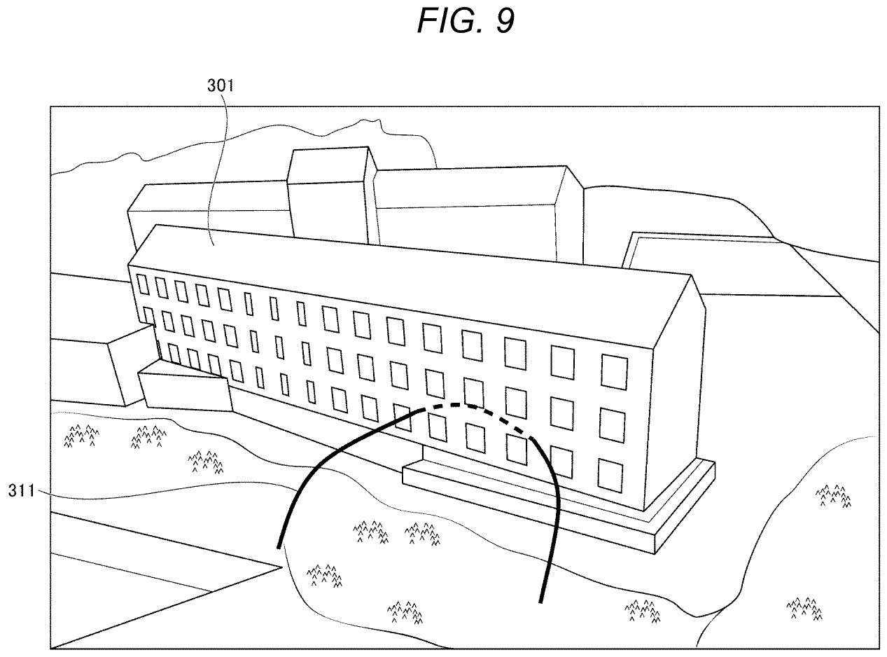

The menu 315 is operated in a case where only one of “imaging range” or “proximity (information)” is selected and displayed. For example, when the “imaging range” is selected, as illustrated in FIG. 8, the planned route 311, the message 312, and the menu 315 disappear from a display screen of FIG. 7, and the imaging range 313 and the imaging range 314 remain. On the other hand, when the “proximity” is selected, as illustrated in FIG. 9, the message 312, the imaging range 313, the imaging range 314, and the menu 315 disappear from the display screen of FIG. 7, and only the planned route 311 remains.

As a result, visibility of the additional information is improved, and the user can select and confirm only necessary information.

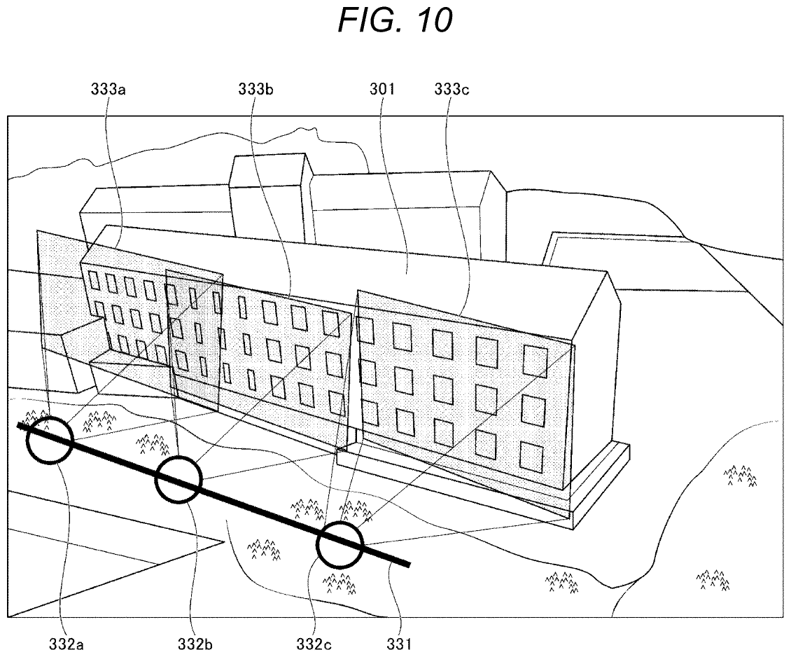

In the example of FIG. 10, similarly to the example of FIG. 7, the three-dimensional model near the building 301 is displayed as area information, and a planned route 331 is superimposed on the area information.

Furthermore, an imaging point 332a to an imaging point 332c, and an imaging range 333a to an imaging range 333c are superimposed on the area information as additional information.

The planned route 311 indicates, by a line, a route on which the drone 11 is scheduled to fly in the execution plan.

The imaging point 332a to the imaging point 332c indicate, by circles, points where the drone 11 is scheduled to perform imaging on the planned route 331 in the execution plan.

The imaging range 333a to the imaging range 333c indicate ranges estimated to be imaged by the drone 11 at the imaging point 332a to the imaging point 332c, respectively. The imaging range 333a and the imaging range 333c partially overlap each other, and display modes of an overlapping portion and a non-overlapping portion are different from each other. For example, a density of a color or pattern of the overlapping portion is higher than a density of a color or pattern of the non-overlapping portion.

As a result, the user can recognize in advance whether or not the imaging target can be imaged as intended. Specifically, for example, the user can recognize in advance whether the imaging range can cover the entire imaging target, whether the imaging ranges overlap each other as intended, or the like.

Hereinafter, in a case where it is not necessary to individually distinguish the imaging point 332a to the imaging point 332c from each other, they each are simply referred to as an imaging point 332. Hereinafter, in a case where it is not necessary to individually distinguish the imaging range 333a to the imaging range 333c from each other, they each are simply referred to as an imaging range 333.

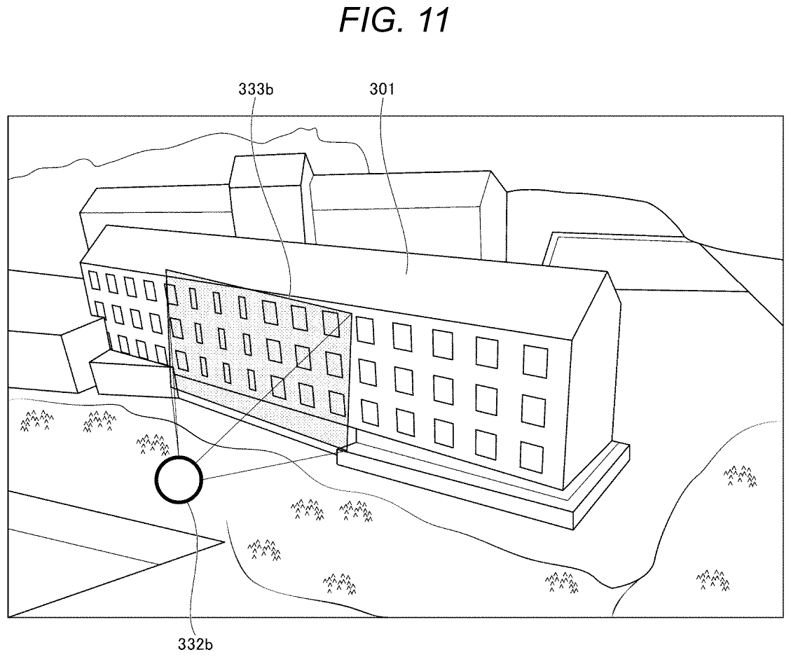

For example, by selecting one of the imaging points 332, the user can display only the imaging range 333 corresponding to the selected imaging point 332. For example, as illustrated in FIG. 11, in a case where the imaging point 332b is selected, the imaging range 333a and the imaging range 333c disappear, and only the imaging range 333b corresponding to the imaging point 332b is displayed.

As a result, the user can individually recognize the imaging range 333 to be imaged from each imaging point 332.

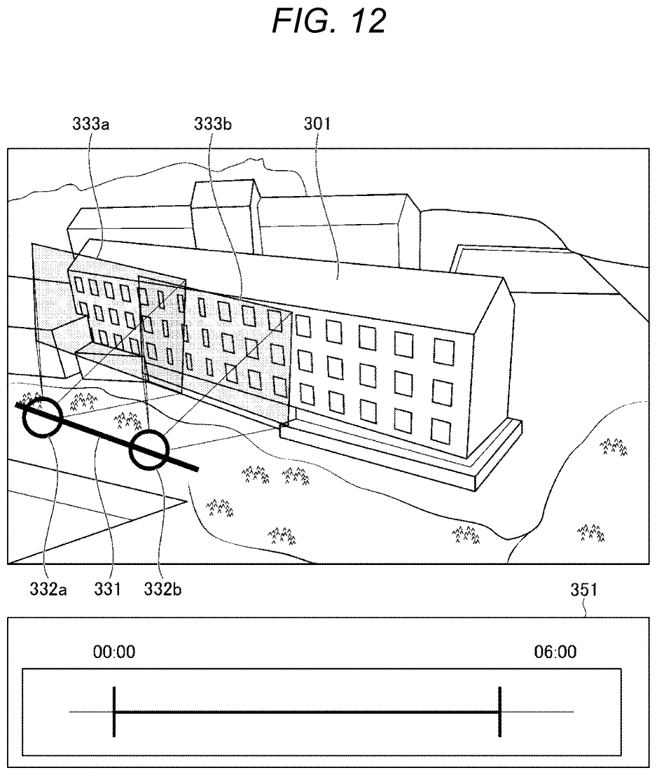

For example, as illustrated in FIG. 12, the user can display the planned route 331, the imaging point 332, and the imaging range 333 within a period designated on a timeline 351. The timeline 351 indicates an elapsed time from a flight start time of the drone 11. Then, displayed are a section (hereinafter, referred to as a designated section) of the planned route 331 on which the drone 11 is scheduled to fly within the period designated on the timeline 351, the imaging point 332 in the designated section, and the imaging range 333 corresponding to the imaging point 332 in the designated section.

For example, in the example of FIG. 12, only the imaging point 332a and the imaging point 332b included in the designated section and the imaging range 333a and the imaging range 333b corresponding to the imaging point 332a and the imaging point 332b are superimposed on the area information.

As a result, the user can easily confirm the imaging state within a desired period.

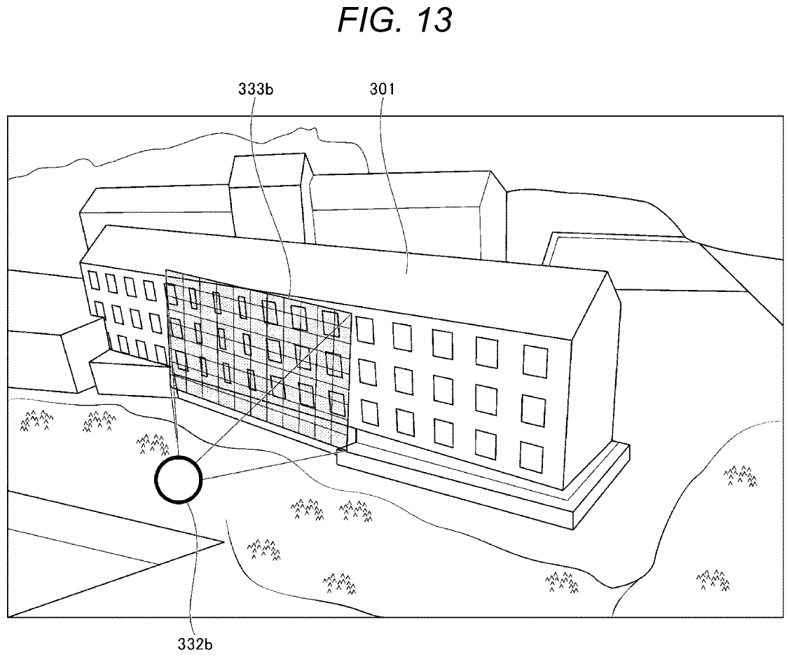

Furthermore, for example, as illustrated in FIG. 13, the resolution (resolving power) estimated for the imaging range 333 may be indicated. Specifically, in the example of FIG. 13, a mesh-like pattern indicating the resolution is displayed to be superimposed on the imaging range 333b. For example, the higher the resolution, the finer the mesh, and the lower the resolution, the coarser the mesh.

As a result, the user can intuitively determine whether or not the imaging target is to be imaged with expected accuracy.

Note that the resolution of the imaging range may be indicated by a pattern other than the mesh-like pattern.

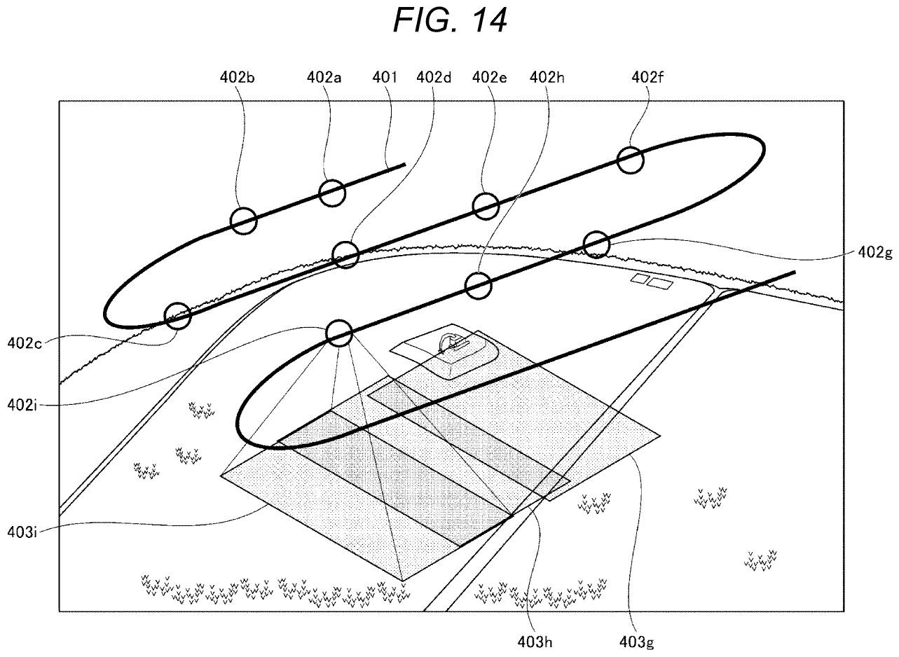

FIG. 14 illustrates a display example of an execution plan in a case where a mission is given of imaging the ground from above.

In the example of FIG. 14, an image or a two-dimensional model including an imaging target area is displayed as area information, and a planned route 401 is Superimposed on the area information. Furthermore, an imaging point 402a to an imaging point 402i, and an imaging range 403g to an imaging range 403i are Superimposed on the area information as additional information.

The planned route 401 indicates, by a line, a route on which the drone 11 is scheduled to fly in the execution plan.

The imaging point 402a to the imaging point 402i indicate, by circles, points where the drone 11 is scheduled to perform imaging on the planned route 401 in the execution plan.

The imaging range 403g to the imaging range 403i indicate ranges estimated to be imaged by the drone 11 at the imaging point 402g to the imaging point 402i, respectively. The imaging point 402g to the imaging point 402i partially overlap each other, and the display modes of overlapping portions and non-overlapping portions are different from each other. For example, a density of a color or pattern of the overlapping portions is higher than a density of the color or pattern of the non-overlapping portions.

Note that, in FIG. 14, for easy understanding of the drawing, illustration is omitted of the imaging ranges 403a to 403f corresponding to the imaging points 402a to 402f. Furthermore, only auxiliary lines connecting the imaging point 402i with the imaging range 403i are illustrated, and illustration of auxiliary lines connecting other imaging points with the imaging ranges are omitted.

As a result, the user can recognize in advance whether or not the imaging target can be imaged as intended. Specifically, for example, the user can recognize in advance whether the imaging range can entirely cover the imaging target, whether the imaging ranges overlap each other as intended, or the like.

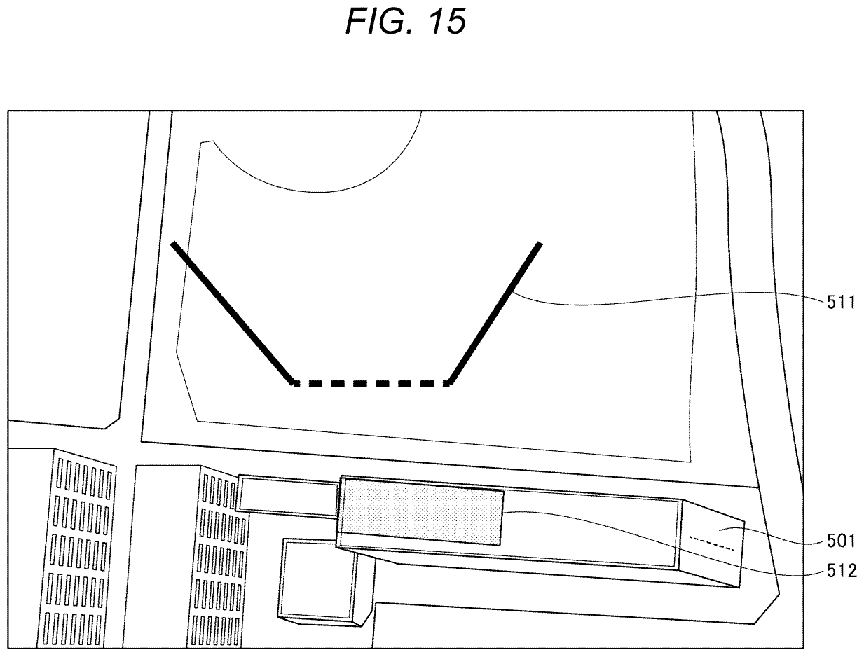

FIG. 15 illustrates a display example of an execution plan in a case where a mission is given of imaging an area including a building 501 on the ground from above.

In this example, an image or a two-dimensional model of a range including the imaging target area is displayed as area information, and a planned route 511 is superimposed on the area information. Furthermore, a dangerous area 512 is superimposed on the area information as additional information.

The planned route 511 indicates, by a line, a flight route of the drone 11 in the execution plan. In the planned route 511, the caution-needed section has a display mode different from those of other sections. In this example, in the planned route 511, a section in which a distance to the building 501 is less than the approach determination threshold is displayed as the caution-needed section by a dotted line. In this way, the caution-needed section, which is one of the additional information, is displayed by a change in the display mode of the planned route 511.

Note that the display modes of the caution-needed section and sections other than the caution-needed section are not particularly limited as long as they can be distinguished from each other.

Furthermore, an area in which a risk that the drone 11 collides with or comes into contact with the building 501 is assumed in the caution-needed section is displayed as the dangerous area 512 having a rectangular shape.

In step S12, the execution plan creation unit 112 of the user terminal 13 determines whether or not to modify the execution plan.

For example, the user determines whether or not to finalize the execution plan by referring to the execution plan displayed on the output unit 103. Then, the user inputs information indicating whether to finalize the execution plan or modify the execution plan via the input unit 101. The input unit 101 supplies, to the control unit 102, input information including the information input.

In response to this, the execution plan creation unit 112 determines whether or not to modify the execution plan on the basis of the input information. In a case where it is determined to modify the execution plan, the processing returns to step S4.

Thereafter, the processing of step S4 to step S12 is repeatedly executed until it is determined in step S12 that the execution plan is finalized. As a result, the mission is modified by the user, and the execution plan is modified accordingly.

Note that the user may directly modify the execution plan.

On the other hand, in a case where it is determined in step S12 that the execution plan is finalized, the processing proceeds to step S13.

In step S13, the execution plan creation unit 112 of the user terminal 13 transmits the execution plan information. For example, the execution plan creation unit 112 transmits the execution plan information to the drone 11 via the communication unit 104 and the network 21 or via the communication unit 104 and the controller 12.

Thereafter, the execution plan creation processing ends.

Thereafter, the drone 11 autonomously executes the mission given by the user on the basis of the execution plan information.

As described above, the user can appropriately create an execution plan for executing a desired mission while confirming whether or not an intended result is obtained before the flight of the drone 11.

For example, the user can easily confirm the flight route of the drone 11 and the imaging state of the drone 11. For example, the user can confirm whether or not the flight route of the drone 11 secures a safe distance from the imaging target. For example, the user can confirm whether the drone 11 can entirely image a necessary part of the imaging target, can perform imaging with an appropriate focus, can perform imaging from an appropriate direction, can perform imaging with an appropriate resolution, and the like. Then, the user can modify the mission and the execution plan as necessary on the basis of confirmed results.

As a result, it is possible to avoid redoing a mission, save time, and reduce a risk at the time of execution of the mission.

### 2. Modifications

Modifications of the above-described embodiment of the present technology will be described hereinafter.

### <Modification Regarding Sharing of Processing>

Sharing of the above-described processing can be appropriately changed.

For example, the user terminal 13 may execute a part or all of the processing by the server 14 described above, or the server 14 may execute a part or all of the processing by the user terminal 13 described above. For example, the user terminal 13 may have a function corresponding to the additional information generation unit 163 of the server 14, and generate additional information on the basis of area information, device information, and execution plan information. For example, the server 14 may have a function corresponding to the execution plan creation unit 112 of the user terminal 13, and create execution plan on the basis of mission information regarding a mission given by the user.

For example, the drone 11 or the controller 12 may execute a part or all of the processing by the user terminal 13 described above.

### <Modification Regarding Method of Displaying Execution Plan>

For example, in a case where the drone 11 is flying according to an execution plan, an actual flight route of the drone may be displayed to be superimposed on a planned route.

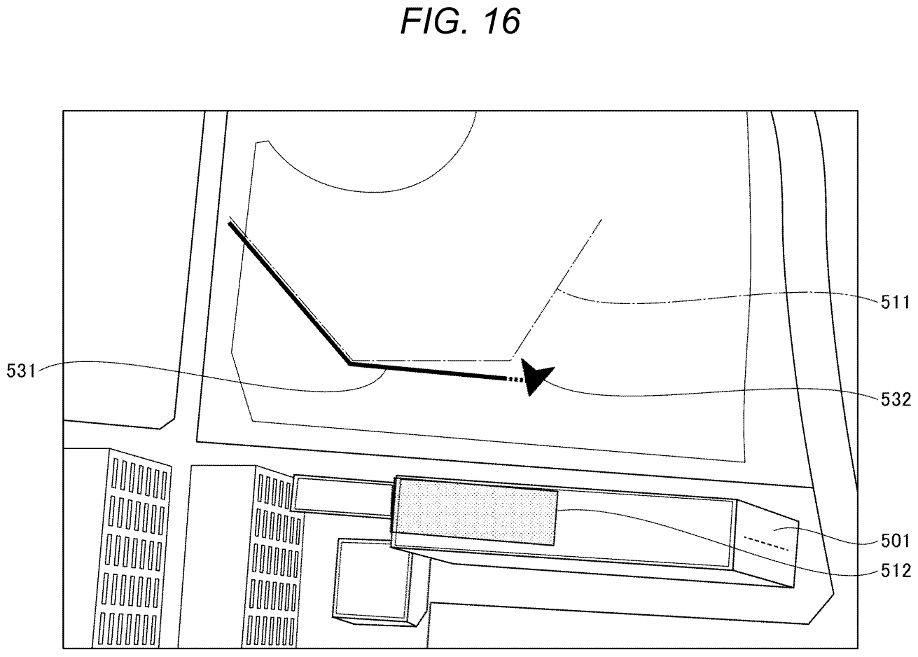

For example, FIG. 16 illustrates an example of a display screen during flight of the drone 11. In this example, a flight route 531 and a current position 532 are newly superimposed on a display screen of FIG. 15.

The flight route 531 indicates an actual route of the drone 11 during the flight. The flight route 531 is displayed in a display mode different from that of the planned route 511 so as to be distinguishable from the planned route 511. Furthermore, in the flight route 531, a section (hereinafter, an approach section) in which a distance between the drone 11 and the building 501 is actually less than the approach determination threshold is displayed in a display mode different from a section (hereinafter, referred to as a non-approach section) that is not the approach section.

Note that the display modes of the planned route 511 and the approach section and the non-approach section of the flight route 531 are not particularly limited as long as they can be distinguished from each other.

The current position 532 indicates a current position of the drone 11.

As a result, for example, the user can confirm whether the drone 11 is flying as planned, safely flying, or the like during the flight of the drone 11.

Furthermore, the user can adjust the flight route of the drone 11 by remotely operating the drone 11 as necessary.

Furthermore, for example, after the drone 11 flies according to the execution plan, an actual flight route of the drone may be displayed to be superimposed on the planned route.

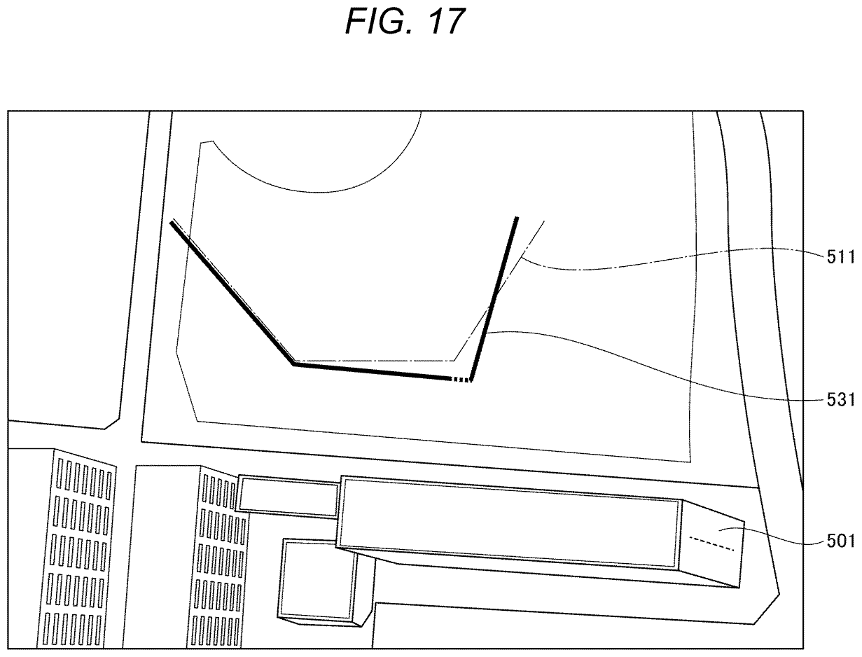

FIG. 17 illustrates an example of a display screen of the drone 11 after the flight. In this example, the flight route 531 is newly superimposed on the display screen of FIG. 15. Furthermore, since it is after the flight and caution is not particularly required, the dangerous area 512 is erased.

The display mode of the flight route 531 is similar to the display mode of the flight route 531 in FIG. 16.

As a result, for example, the user can confirm whether the drone 11 has flown as planned after the flight of the drone 11.

### <Other Modifications>

For example, instead of the user, the user terminal 13 or another apparatus may generate a mission. For example, the user terminal 13 or another apparatus may automatically generate a mission that needs to be newly executed on the basis of an execution history of past missions.

The present technology can be applied not only to a drone but also to an autonomous flight object that autonomously flies according to a mission and can execute the mission. For example, the present technology can be applied to a flying car or the like that autonomously executes a mission.

The present technology can be applied not only to an autonomous flight object but also to an autonomous mobile object that autonomously moves according to a mission and can execute the mission. For example, the present technology can be applied to an automated vehicle that autonomously executes a mission.

### 3. Others

### <Configuration Example of Computer>

The above-described series of processing can be performed by hardware or software. In a case where the series of processing is performed by software, a program that makes up the software is installed in a computer. Here, examples of the computer include a computer incorporated in dedicated hardware, a computer that can execute various functions by installation of various programs, for example, a general-purpose personal computer, and the like.

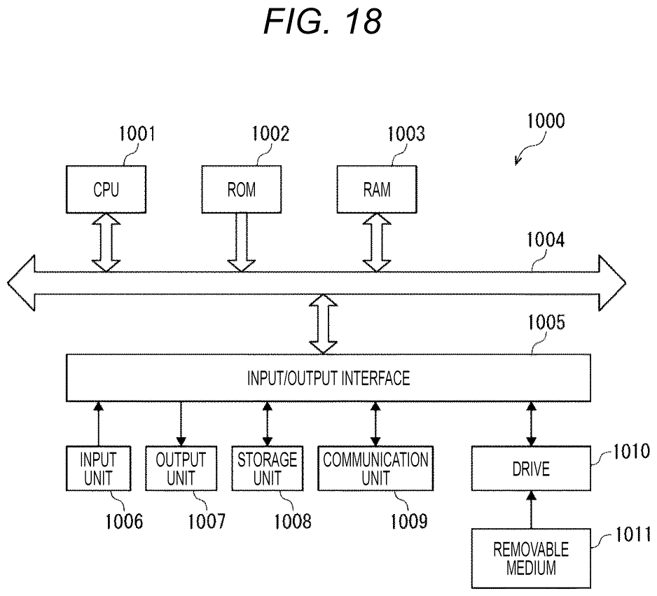

FIG. 18 is a block diagram illustrating a configuration example of hardware of a computer that executes the above-described series of processing by a program.

In a computer 1000, a central processing unit (CPU) 1001, a read only memory (ROM) 1002, and a random access memory (RAM) 1003 are interconnected via a bus 1004.

An input/output interface 1005 is further connected to the bus 1004. An input unit 1006, an output unit 1007, a storage unit 1008, a communication unit 1009, and a drive 1010 are connected to the input/output interface 1005.

The input unit 1006 includes an input switch, a button, a microphone, an imaging element, or the like. The output unit 1007 includes a display, a speaker, or the like. The storage unit 1008 includes a hard disk, a nonvolatile memory, or the like. The communication unit 1009 includes a network interface or the like. The drive 1010 drives a removable medium 1011 such as a magnetic disk, an optical disc, a magneto-optical disk, or a semiconductor memory.

In the computer 1000 configured as described above, the series of processing described above is performed, for example, by the CPU 1001 loading a program stored in the storage unit 1008 into the RAM 1003 via the input/output interface 1005 and the bus 1004 and executing the program.

The program executed by the computer 1000 (CPU 1001) can be provided by being recorded in the removable medium 1011 as, for example, a package medium or the like. Furthermore, the program can be provided via a wired or wireless transmission medium such as a local area network, the Internet, or digital satellite broadcasting.

In the computer 1000, the program can be installed in the storage unit 1008 via the input/output interface 1005 by having the removable medium 1011 attached to the drive 1010. Furthermore, the program can be received by the communication unit 1009 via the wired or wireless transmission medium to be installed in the storage unit 1008. Alternatively, the program can be installed in the ROM 1002 or the storage unit 1008 in advance.

Note that the program to be executed by the computer may be a program that performs processing in time-series order described in the present specification, or may be a program that performs processing in parallel or at necessary timing such as when a call is made.

Furthermore, in the present specification, a system means a set of a plurality of constituent elements (apparatuses, modules (components), or the like), and it does not matter whether or not all the constituent elements are in the same housing. Thus, a plurality of apparatuses housed in separate housings and connected to each other via a network, and one apparatus including a plurality of modules housed in one housing, are both systems.

Moreover, the embodiment of the present technology is not limited to the above-described embodiment, and various modifications can be made without departing from the gist of the present technology.

For example, the present technology may be embodied in cloud computing in which one function is shared and processed by a plurality of devices in cooperation via a network.

Furthermore, the steps described in the flowchart described above may be executed by one apparatus, or may be executed by a plurality of apparatuses in a shared manner.

Moreover, in a case where a plurality of pieces of processing is included in one step, the plurality of pieces of processing included in the one step can be executed by one apparatus or executed by a plurality of apparatuses in a shared manner.

### <Example of Combination of Configurations>

The present technology can also have the following configurations.
(1)

An information processing apparatus including
an output control unit that controls display of execution plan information regarding an execution plan for an autonomous mobile object to execute a mission, area information regarding an execution area where the mission is to be executed, and additional information applicable to determination of validity of the execution plan.
(2)

The information processing apparatus according to (1), in which
the mission includes a mission of imaging an imaging target, and
the additional information includes imaging state information regarding an imaging state of the imaging target by an imaging device included in the autonomous mobile object.
(3)

The information processing apparatus according to (2), in which
the imaging state information includes at least one of an imaging range by the imaging device, an imaging direction for the imaging target, a focus state with respect to the imaging target, or a resolution of the imaging target.
(4)

The information processing apparatus according to (3), in which
the output control unit performs control to display the imaging range in different display modes on the basis of at least one of the imaging direction or the focus state.
(5)

The information processing apparatus according to (3) or (4), in which
the output control unit performs control to display a portion where a plurality of the imaging ranges Overlaps each other in a display mode different from a display mode of another portion.
(6)

The information processing apparatus according to any of (3) to (5), in which
the output control unit performs control to display a pattern indicating the resolution of the imaging target in a superimposed manner on the imaging range.
(7)

The information processing apparatus according to any of (2) to (6), further including
an additional information generation unit that generates the additional information including the imaging state information on the basis of the area information, the execution plan information, and device information regarding the imaging device.
(8)

The information processing apparatus according to (1), in which
the execution plan information includes a planned route that is a movement route of the autonomous mobile object planned, and
the additional information includes information regarding a caution-needed section in which there is a risk of collision or contact with a surrounding object in the planned route.
(9)

The information processing apparatus according to (8), in which
the output control unit performs control to display the planned route such that the caution-needed section and another section are displayed in different display modes.
(10)

The information processing apparatus according to (8) or (9), in which
the output control unit controls display of an area in which there is a risk of collision or contact of the autonomous mobile object in the caution-needed section.
(11)

The information processing apparatus according to any of (8) to (10), in which
the output control unit performs control to display the planned route and an actual movement route of the autonomous mobile object in an overlapping manner at least one of during movement or after movement of the autonomous mobile object.
(12)

The information processing apparatus according to any of (8) to (11), in which
the caution-needed section is set on the basis of a distance between the planned route and the surrounding object.
(13)

The information processing apparatus according to (12), in which
the caution-needed section is set further on the basis of at least one of operation information on the autonomous mobile object or environmental information around the planned route.
(14)

The information processing apparatus according to any of (8) to (13), further including
an additional information generation unit that generates the additional information including the caution-needed section on the basis of the area information and the planned route.
(15)

The information processing apparatus according to any of (1) to (14), further including
an execution plan creation unit that creates the execution plan on the basis of mission information regarding the mission and the area information.
(16)

The information processing apparatus according to (1), further including
an additional information generation unit that generates the additional information on the basis of the execution plan information and the area information.
(17)

The information processing apparatus according to any of (1) to (16), in which
the area information includes at least one of map information, an image, a two-dimensional model, or a three-dimensional model near the execution area.
(18)

The information processing apparatus according to any of (1) to (17), in which
the autonomous mobile object is an autonomous flight object.
(19)

An information processing method including:
controlling, by an information processing apparatus, display of execution plan information regarding an execution plan for an autonomous mobile object to execute a mission, area information regarding an execution area where the mission is to be executed, and additional information applicable to determination of validity of the execution plan.
(20)

An information processing system including:
an execution plan creation unit that creates an execution plan for an autonomous mobile object to execute a mission on the basis of mission information regarding the mission to be executed by the autonomous mobile object and area information regarding an execution area where the mission is to be executed;
an additional information generation unit that generates additional information applicable to determination of validity of the execution plan on the basis of execution plan information regarding the execution plan and the area information; and
an output control unit that controls display of the execution plan information, the area information, and the additional information,
in which
the execution plan creation unit, the additional information generation unit, and the output control unit are each disposed in any of two or more information processing apparatuses.

Note that, the effects described in the present specification are merely examples and are not limited, and other effects may be provided.

### REFERENCE SIGNS LIST

1 Information processing system
11 Drone
12 Controller
13 User terminal
14 Server
102 Control unit
103 Output unit
104 Communication unit
111 Information acquisition unit
112 Execution plan creation unit
113 Output control unit
114 Remote control unit
151 Control unit
152 Communication unit
161 Information acquisition unit
162 Area information generation unit
163 Additional information generation unit

1. An information processing apparatus comprising
an output control unit that controls display of execution plan information regarding an execution plan for an autonomous mobile object to execute a mission, area information regarding an execution area where the mission is to be executed, and additional information applicable to determination of validity of the execution plan.

2. The information processing apparatus according to claim 1, wherein
the mission includes a mission of imaging an imaging target, and
the additional information includes imaging state information regarding an imaging state of the imaging target by an imaging device included in the autonomous mobile object.

3. The information processing apparatus according to claim 2, wherein
the imaging state information includes at least one of an imaging range by the imaging device, an imaging direction for the imaging target, a focus state with respect to the imaging target, or a resolution of the imaging target.

4. The information processing apparatus according to claim 3, wherein
the output control unit performs control to display the imaging range in different display modes on a basis of at least one of the imaging direction or the focus state.

5. The information processing apparatus according to claim 3, wherein
the output control unit performs control to display a portion where a plurality of the imaging ranges overlaps each other in a display mode different from a display mode of another portion.

6. The information processing apparatus according to claim 3, wherein
the output control unit performs control to display a pattern indicating the resolution of the imaging target in a superimposed manner on the imaging range.

7. The information processing apparatus according to claim 2, further comprising
an additional information generation unit that generates the additional information including the imaging state information on a basis of the area information, the execution plan information, and device information regarding the imaging device.

8. The information processing apparatus according to claim 1, wherein
the execution plan information includes a planned route that is a movement route of the autonomous mobile object planned, and
the additional information includes information regarding a caution-needed section in which there is a risk of collision or contact with a surrounding object in the planned route.

9. The information processing apparatus according to claim 8, wherein
the output control unit performs control to display the planned route such that the caution-needed section and another section are displayed in different display modes.

10. The information processing apparatus according to claim 8, wherein
the output control unit controls display of an area in which there is a risk of collision or contact of the autonomous mobile object in the caution-needed section.

11. The information processing apparatus according to claim 8, wherein
the output control unit performs control to display the planned route and an actual movement route of the autonomous mobile object in an overlapping manner at least one of during movement or after movement of the autonomous mobile object.

12. The information processing apparatus according to claim 8, wherein
the caution-needed section is set on a basis of a distance between the planned route and the surrounding object.

13. The information processing apparatus according to claim 1, wherein
the caution-needed section is set further on a basis of at least one of operation information on the autonomous mobile object or environmental information around the planned route.

14. The information processing apparatus according to claim 8, further comprising
an additional information generation unit that generates the additional information including the caution-needed section on a basis of the area information and the planned route.

15. The information processing apparatus according to claim 1, further comprising
an execution plan creation unit that creates the execution plan on a basis of mission information regarding the mission and the area information.

16. The information processing apparatus according to claim 1, further comprising
an additional information generation unit that generates the additional information on a basis of the execution plan information and the area information.

17. The information processing apparatus according to claim 1, wherein
the area information includes at least one of map information, an image, a two-dimensional model, or a three-dimensional model near the execution area.

18. The information processing apparatus according to claim 1, wherein
the autonomous mobile object is an autonomous flight object.

19. An information processing method comprising:
controlling, by an information processing apparatus, display of execution plan information regarding an execution plan for an autonomous mobile object to execute a mission, area information regarding an execution area where the mission is to be executed, and additional information applicable to determination of validity of the execution plan.

20. An information processing system comprising:
an execution plan creation unit that creates an execution plan for an autonomous mobile object to execute a mission on a basis of mission information regarding the mission to be executed by the autonomous mobile object and area information regarding an execution area where the mission is to be executed;
an additional information generation unit that generates additional information applicable to determination of validity of the execution plan on a basis of execution plan information regarding the execution plan and the area information; and
an output control unit that controls display of the execution plan information, the area information, and the additional information,
wherein
the execution plan creation unit, the additional information generation unit, and the output control unit are each disposed in any of two or more information processing apparatuses.
